(19) United States
(12) Patent Application Publication
(10) Pub. No.: US 2020/0010048 A1
(43) Pub. Date: Jan. 9, 2020

(54) VEHICLE, RING-TYPE APPARATUS, AND VEHICLE SYSTEM

(71) Applicants: Hyundai Motor Company, Seoul (KR); Kia Motors Corporation, Seoul (KR)

(72) Inventors: Mingu Park, Gyeonggi-do (KR); Hyung Gyu Ra, Gyeonggi-do (KR); Jaekwon Jung, Yongin (KR)

(21) Appl. No.: 16/174,199

(22) Filed: Oct. 29, 2018

(30) Foreign Application Priority Data
Jul. 9, 2018 (KR) 10-2018-0079103

(51) Int. Cl. B60R 25/24; H04W 12/06; H04L 9/32

(52) U.S. Cl. CPC B60R 25/24; B60R 2325/108; H04L 9/32; H04W 12/06

(57) ABSTRACT

A vehicle may include: a conductive coil; and an authenticator configured to be turned on in response to receiving a current and to request an encryption key from a remote control apparatus. An induction current may be induced in the coil when a magnetic body approaches the coil, and the authenticator may be further configured to be activated in response to receiving the induction current from the coil.

### CROSS-REFERENCE TO RELATED APPLICATION

This application is based on and claims priority under 35 U.S.C. § 119 to Korean Patent Application No. 10-2018-0079103, filed on Jul. 9, 2018 in the Korean Intellectual Property Office, the disclosure of which is incorporated herein by reference in its entirety.

### BACKGROUND

### 1. Technical Field

The present disclosure relates generally to vehicular technologies and, more particularly, to a vehicle, a ring-type apparatus, and a vehicle system including the vehicle and the ring-type apparatus.

### 2. Description of the Related Art

Conventional remote control systems for a vehicle can allow a user to perform a variety of remote operations, such as opening and closing a vehicle door or starting the vehicle without inserting a key into an ignition of the vehicle. Remote control systems typically use a portable remote control apparatus, such as a smartcard or a FOB, for wireless communication.

In recent years, various technologies have been developed that allow handheld-based wearable devices to control a vehicle. However, conventional wearable devices require a battery mounted therein to communicate wirelessly with the vehicle.

### SUMMARY

Therefore, it is an object of the present disclosure to provide a ring-type apparatus having portability and convenience. It is another object of the present disclosure to provide a vehicle that is activated by the ring-type apparatus. It is another object of the present disclosure to provide a vehicle capable of performing user authentication with the ring-type apparatus.

Additional aspects of the disclosure will be set forth in part in the description which follows and, in part, will be apparent from the description, or may be learned by practice of the disclosure.

In accordance with embodiments of the present disclosure, a vehicle may include: a conductive coil; and an authenticator configured to be turned on in response to receiving a current and to request an encryption key from a remote control apparatus. An induction current may be induced in the coil when a magnetic body approaches the coil, and the authenticator may be further configured to be activated in response to receiving the induction current from the coil.

The vehicle may further include a handle configured to open a door of the vehicle. The coil may be disposed in the handle or adjacent to the handle.

The authenticator may be further configured to receive an encryption key from the remote control apparatus, to compare the received encryption key with a pre-stored encryption key, and to authenticate the remote control apparatus based on the comparison of the received encryption key with the pre-stored encryption key.

Furthermore, in accordance with embodiments of the present disclosure, a vehicle system may include: a ring-type apparatus including a magnetic body; a vehicle including a conductive coil and an authenticator configured to be activated in response to receiving a current and to request an encryption key from a remote control apparatus; and the remote control apparatus which is configured to transmit a pre-stored encryption key to the authenticator in response to receiving an encryption key request signal. An induction current may be induced in the coil when the magnetic body of the ring-type apparatus approaches the coil, and the authenticator may be further configured to be activated in response to receiving the induction current from the coil.

The magnetic body of the ring-type apparatus may include at least one of a magnet iron, an electromagnet, and a permanent magnet.

The authenticator of the vehicle may be configured to receive an encryption key from the remote control apparatus, to compare the received encryption key with a pre-stored encryption key, and to authenticate the remote control apparatus based on the comparison of the received encryption key with the pre-stored encryption key.

The ring-type apparatus may include a ring.

Furthermore, in accordance with embodiments of the present disclosure, a vehicle may include: a conductive coil; a wake-up portion configured to sense an input from a user and to supply the coil with a current in response to sensing the input from the user; and an authenticator configured to receive an encryption key. The coil may be magnetized in response to receiving a current.

The wake-up portion may be further configured to supply the authenticator with the current in response to sensing the input from the user.

The authenticator may be further configured to be turned on in response to receiving the current from the wake-up portion.

The authenticator may be further configured to transmit an encryption key request signal in response to receiving the current from the wake-up portion.

The vehicle may further include a handle configured to open a door of the vehicle. The coil may be disposed in the handle or adjacent to the handle.

The authenticator may be further configured to compare the received encryption key with a pre-stored encryption key and to authenticate the remote control apparatus based on the comparison of the received encryption key with the pre-stored encryption key.

The wake-up portion may include an input device in the form of a button to be pressed. The input device may be configured to supply the coil with a current in response to being pressed.

The vehicle may further include a handle configured to open a door of the vehicle. The input device may be disposed in the handle or adjacent to the handle.

The wake-up portion may include an input device in the form of a touch pad. The input may be configured to supply the coil with a current in response to being touched.

The vehicle may further include a handle configured to open a door of the vehicle. The input device may be disposed in the handle or adjacent to the handle.

Furthermore, in accordance with embodiments of the present disclosure, a ring-type apparatus may include: a coil configured to generate a current when a magnetic body approaches the coil; and an authenticator configured to transmit a pre-stored encryption key in response to receiving the current from the coil.

The ring-type apparatus may include a ring.

The authenticator may be configured to be turned on in response to receiving the current from the coil and to transmit a pre-stored encryption key in response to receiving an encryption key request signal.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating an exterior of a vehicle according to embodiments of the present disclosure;

FIG. 2 is a view illustrating an interior of a vehicle according to embodiments of the present disclosure;

FIG. 3 is a control block diagram illustrating a vehicle system according to embodiments of the present disclosure;

FIG. 4 is a conceptual diagram illustrating a vehicle, a ring-type apparatus, and a remote control apparatus according to embodiments of the present disclosure;

FIG. 5 is an exemplary view illustrating an example in which a ring-type apparatus according to embodiments of the present disclosure is used;

FIGS. 6 and 7 are exemplary views of a vehicle system including a ring-type apparatus according to embodiments of the present disclosure;

FIG. 8 is an additional control block diagram illustrating a vehicle system according to embodiments of the present disclosure;

FIG. 9 is an additional conceptual diagram illustrating a vehicle and a ring-type apparatus according to embodiments of the present disclosure; and

FIGS. 10 and 11 are exemplary views illustrating an additional example in which a ring-type apparatus according to embodiments of the present disclosure is used.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Hereinafter, embodiments of the present disclosure will be described in detail with reference to the accompanying drawings. As those skilled in the art would realize, the described embodiments may be modified in various different ways, all without departing from the spirit or scope of the present disclosure. In the description, like numerals refer to like elements throughout the specification.

Not all elements of embodiments of the present disclosure will be described, and description of what are commonly known in the art or what overlap each other in the embodiments will be omitted. The terms as used throughout the specification, such as “˜part”, “˜module”, “˜member”, “˜block”, etc., may be implemented in software and/or hardware, and a plurality of “˜parts”, “˜modules”, “˜members”, or “˜blocks” may be implemented in a single element, or a single “˜part”, “˜module”, “˜member”, or “˜block” may include a plurality of elements.

It will be further understood that the term “connect” or its derivatives refer both to direct and indirect connection, and the indirect connection includes a connection over a wireless communication network.

The term “include (or including)” or “comprise (or comprising)” is inclusive or open-ended and does not exclude additional, unrecited elements or method steps, unless otherwise mentioned.

It will be understood that, although the terms first, second, etc. may be used herein to describe various elements, these elements should not be limited by these terms. These terms are only used to distinguish one element from another.

It is to be understood that the singular forms “a,” “an,” and “the” include plural references unless the context clearly dictates otherwise.

Reference numerals used for method steps are just used for convenience of explanation, but not to limit an order of the steps. Thus, unless the context clearly dictates otherwise, the written order may be practiced otherwise.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one control unit (or apparatus). The term “control unit” may refer to a hardware device that includes a memory and a processor. The memory is configured to store program instructions, and the processor is specifically programmed to execute the program instructions to perform one or more processes which are described further below. The control unit may control operation of units, modules, parts, devices, or the like, as described herein. Moreover, it is understood that the below methods may be executed by an apparatus comprising the control unit in conjunction with one or more other components, as would be appreciated by a person of ordinary skill in the art.

Furthermore, the control unit of the present disclosure may be embodied as non-transitory computer readable media containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed throughout a computer network so that the program instructions are stored and executed in a distributed fashion, e.g., by a telematics server or a Controller Area Network (CAN).

Hereinafter, the principles and embodiments of the present disclosure will be described with reference to the accompanying drawings.

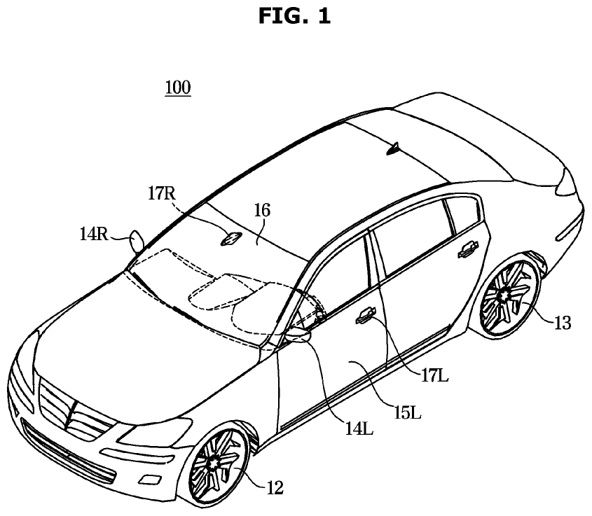

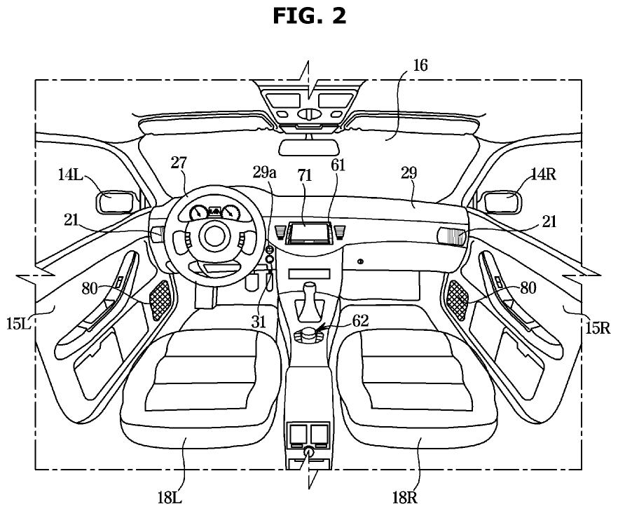

FIG. 1 is a view illustrating an exterior of a vehicle according to embodiments of the present disclosure, and FIG. 2 is a view illustrating an interior of a vehicle according to embodiments of the present disclosure.

Referring first to FIG. 1, the external appearance of a vehicle 100 according to an embodiment includes wheels 12 and 13 for moving the vehicle 100, a door 15L for shielding the inside of the vehicle 100 from the outside, a front glass 16 for providing the driver inside the vehicle 100 with a front view of the vehicle 100 and side mirrors 14L and 14R for providing the driver with a rear view of the vehicle 100.

The wheels 12 and 13 include a front wheel 12 provided at the front of the vehicle 100 and a rear wheel 13 provided at the rear of the vehicle 100. A driving device (not shown) provided inside the vehicle 100 provides the front wheel 12 or the rear wheel 13 with a rotary force to move the vehicle 1 forward or backward. Such a driving device may be implemented using an engine that generates a rotary force by burning fossil fuel, or a motor that generates a rotary force by receiving power from a capacitor.

The doors 15L and 15R (see FIG. 2) are rotatably provided on the left and right sides of the vehicle 100 to allow the driver or the passenger to ride on the inside of the vehicle 100 when the doors 15L and 15R are opened and to shield the inside of the vehicle 100 from the outside when the doors 15L and 15R are closed. In addition, the vehicle 100 is provided on the outer side with handles 17L and 17R for opening and closing the doors 15L and 15R (see FIG. 2).

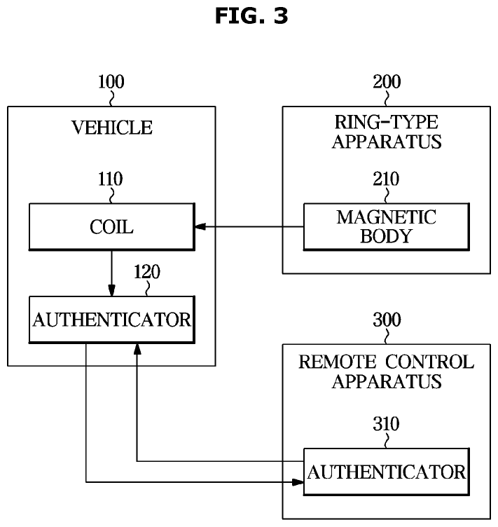

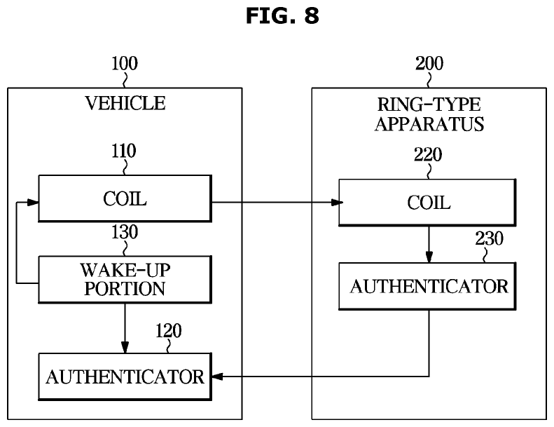

In a state in which a user is holding a remote control apparatus 300 (see FIG. 3) or a ring-type apparatus 200 (see FIG. 8) that shares an encryption key with the vehicle 100, when an authentication between the vehicle 100 and the remote control apparatus 300 is completed according to an embodiment or an authentication between the vehicle 100 and the ring-type apparatus 200 is completed according to another embodiment, a door-lock of the vehicle 100 is released according to a vehicle control of the user, and the door 15L may be opened by a user manipulation of pulling the handle 17L or 17R. Here, the user refers to not only the driver but also the passenger riding the vehicle 100, that is, a person who holds the ring-type apparatus 200.

The front glass 16 is provided on the front upper side of a main body such that the driver inside the vehicle 100 obtains front view information of the vehicle 100, and is also referred to as a windshield glass.

In addition, the side mirrors 14L and 14R include a left side mirror 14L provided on the left side of the vehicle 100 and a right side mirror 14R provided on the right side of the vehicle 100 such that the driver inside the vehicle 100 obtains side view information or rear view information of the vehicle 100.

In addition, the vehicle 100 may include a sensing device, such as a proximity sensor for detecting an obstacle behind or at a lateral side of the vehicle 100, or other vehicles, a rain sensor for detecting rainfall and the amount of rainfall, and a camera.

It is understood that the exterior of the vehicle 100 as illustrated in FIG. 1 and described above is provided merely for demonstration purposes, and thus does not limit the scope of the present disclosure.

Referring next to FIG. 2, an Audio Video Navigation (AVN) display 71 and an AVN input 61 may be provided in a central area of a dashboard 29. The AVN display 71 may selectively display at least one of an audio screen, a video screen, and a navigation screen, as well as various control screens related to the vehicle 100 or additional function screens related to the vehicle 100.

The AVN display 71 may be implemented as a Liquid Crystal Display (LCD), a Light Emitting Diode (LED), a Plasma Display Panel (PDP), an Organic Light Emitting Diode (OLED), a Cathode Ray Tube (CRT), and the like.

The AVN input 61 may be provided adjacent to the AVN display 71 in the form of a hard key. When the AVN display 71 may be implemented as a touch screen type display, the AVN input 61 may be provided in the front of the AVN display 71 in the form of a touch panel.

In addition, a center input 62 may be provided between a driver seat 18L and a passenger seat 18R in the form of a jog shuttle. The user may input a control command in such a manner to turn or press the center input 62 or push the center input 62 in the up, down, left, or right direction.

The vehicle 100 may be provided with an acoustic output 80 capable of outputting sound, and the acoustic output 80 may be a speaker. The acoustic output 80 may output sounds required for performing an audio function, a video function, a navigation function, and other additional functions.

A steering wheel 27 is provided on a side of the dashboard 29 adjacent to the driver seat 18L, and a key groove 29a into which a FOB (not shown) is insertable is formed in an area of the dashboard 29 adjacent to the steering wheel 27. When the FOB is inserted into the key groove 29a, or an authentication between the FOB or a portable terminal 200 and the vehicle 100 through a wireless communication network is completed, the FOB or the portable terminal 200 may be connected to the vehicle 100.

The dashboard 29 may be provided with a start button 31 for controlling on/off of the start of the vehicle 100. When the FOB is inserted into the key groove 29a or an authentication is performed by authentication data (hereinafter, referred to as “a token” transmitted and received between a vehicle short-range communication module provided adjacent to the start button 31 and a terminal short-range communication module of the portable terminal 200 registered in the vehicle 100, and then the start button 31 is pressed by the user, the start of the vehicle 100 may be turned on.

Meanwhile, the vehicle 100 is provided with an air conditioner to perform both heating and cooling, and the temperature inside the vehicle 100 may be controlled by discharging heated or cooled air through a vent 21.

It is understood that the interior of the vehicle 100 as illustrated in FIG. 2 and described above is provided merely for demonstration purposes, and thus does not limit the scope of the present disclosure.

FIG. 3 is a control block diagram illustrating a vehicle system according to embodiments of the present disclosure.

As shown in FIG. 3, a vehicle system according to embodiments of the present disclosure includes a vehicle 100, a ring-type apparatus 200, and a remote control apparatus 300.

The vehicle 100 and the remote control apparatus 300 according to the embodiment may be connected to each other via a wireless communication network.

Here, the wireless communication network may include a Global System for Mobile Communication (GSM), a Code Division Multiple Access (CDMA), a Wideband Code Division Multiple Access (WCDMA), a universal mobile telecommunications system (UMTS), a time division multiple access (TDMA), Long Term Evolution (LTE), Wireless LAN, Wi-Fi, Bluetooth, Zigbee, Wi-Fi Direct (WFD), ultra wideband (UWB), infrared Data Association (IrDA), Bluetooth Low Energy (BLE), Near Field Communication (NFC), and radio frequency identification (RFID), and the like. The wireless communication network according to the present disclosure is not limited thereto.

The ring-type apparatus 200 may be implemented as a wearable device, such as a ring, and it may be assumed that the ring-type apparatus 200 and the remote control apparatus 300 are owned by the same user.

According to embodiments of the present disclosure, the vehicle 100 includes a coil 110 and an authenticator 120, the ring-type apparatus 200 includes a magnetic body 210, and the remote control apparatus 300 includes an authenticator 310.

The coil 110 of the vehicle 100 is formed of a conductive material, and a current flows through the coil 110 according to electromagnetic induction laws when the magnetic body 210 approaches the coil 110. For example, when a user wearing the ring-type apparatus 200 allows the ring-type apparatus 200 to approach the coil 110 of the vehicle 100, an induction current may be generated in the coil 110 of the vehicle 100, and the coil 110 may supply the generated current to the authenticator 120 of the vehicle 100.

The authenticator 120 of the vehicle 100 according to embodiments of the present disclosure is activated (e.g., turned on, woken up, etc.) in response to receiving a current, and the activated authenticator 120 may request an encryption key from the remote control apparatus 300. Then, the authenticator 120 may receive the encryption key from the remote control apparatus 300, compare the received encryption key with a pre-stored encryption key to determine whether the encryption keys match each other, and authenticate the remote control apparatus 300 when the encryption keys match each other.

The authenticator 120 of the vehicle 100 may include a wireless communication interface including an antenna and a transceiver for transmitting and receiving a wireless signal to and from the remote control apparatus 300. In addition, the authenticator 120 may further include a signal conversion module for modulating a digital control signal into an analog type wireless signal through the wireless communication interface or for demodulating an analog type wireless signal received through the wireless communication interface into a digital control signal.

The authenticator 120 of the vehicle 100 includes a processor that performs a series of operations to process data and a memory that stores an algorithm for processing data or data about a program that reproduces an algorithm.

The magnetic body 210 of the ring-type apparatus 200 according to the embodiment is a substance having magnetic properties, and includes at least one of a magnet iron, an electromagnet, and a permanent magnet.

When the magnetic body 210 approaches the coil 110 of the vehicle 100, the magnetic body 210 may cause an induction current to be generated in the coil 110.

The remote control apparatus 300 according to embodiments of the present disclosure may be implemented as a computer or a portable terminal capable of connecting to the vehicle 100 through a wireless communication network. Here, the computer may include, for example, a notebook, a desktop, a laptop, a tablet PC, a slate PC, and the like, on which a Web Browser is mounted, and the portable terminal may include all types of handheld-based wireless communication devices, such as a Personal Communication System (PCS), Global System for Mobile communications (GSM), Personal Digital Cellular (PDC), Personal Handyphone System (PHS), Personal Digital Assistant(PDA), an International Mobile Telecommunication (IMT), a Code Division Multiple Access (CDMA)-2000, W-Code Division Multiple Access (W-CDMA), Wireless Broadband Internet (WiBro) terminals, smart phones; a wearable device, such as a watch, a ring, a bracelet, an ankle bracelet, a neckless, glasses, a contact lens, or a head-mounted-device (HMD); or a FOB key.

The authenticator 310 of the remote control apparatus 300 according to embodiments of the present disclosure may receive an encryption key request signal from the vehicle 100, and transmit an encryption key that is pre-stored in the remote control apparatus 300 to the vehicle 100 in response to receiving the encryption key request signal.

The authenticator 310 of the remote control apparatus 300 may include a wireless communication interface including an antenna and a transceiver for transmitting and receiving a wireless signal to and from the vehicle 100. In addition, the authenticator 310 may further include a signal conversion module for modulating a digital control signal into an analog type wireless signal through the wireless communication interface or for demodulating an analog type wireless signal received through the wireless communication interface into a digital control signal.

In addition, the authenticator 310 of the remote control apparatus 300 may be implemented as a transponder that automatically transmits an encryption key in response to receiving an encryption key request signal.

The authenticator 310 of the remote control apparatus 300 includes a processor that performs a series of operations to process data and a memory that stores an algorithm for processing data or data about a program that reproduces an algorithm.

Although not shown, the remote control apparatus 300 according to embodiments of the present disclosure may further include an input for sensing a user input, and when the vehicle 100 authenticates the remote control apparatus 300, the control of the vehicle may be performed according to a manipulation of the input.

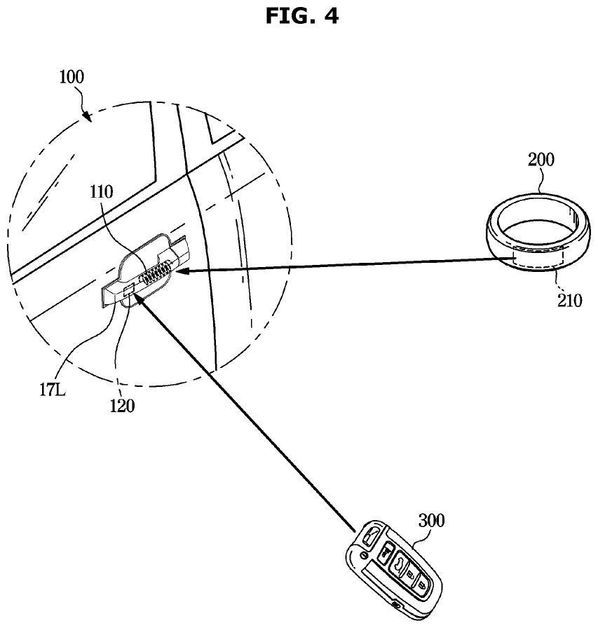

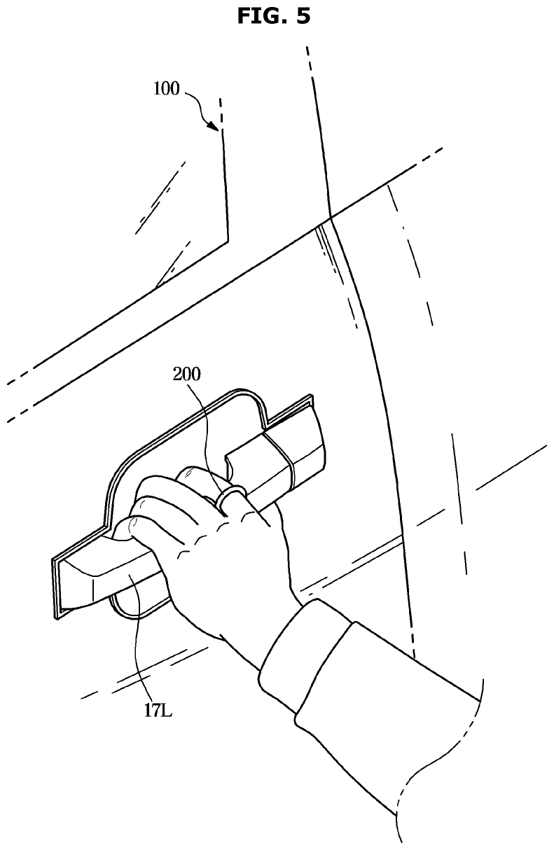

FIG. 4 is a conceptual diagram illustrating a vehicle, a ring-type apparatus, and a remote control apparatus according to embodiments of the present disclosure, and FIG. 5 is an exemplary view illustrating a ring-type apparatus according to embodiments of the present disclosure.

Referring first to FIG. 4, at least one of the coil 110 and the authenticator 120 of the vehicle 100 described above may be provided in the door 15L or 15R of the vehicle 100 described above with reference to FIGS. 1 and 2, in detail, in the handle 17L or 17R or adjacent to the handle 17L or 17R. However, the position of the at least one of the coil 110 and the authenticator 120 of the vehicle 100 is not limited thereto.

Referring next to FIG. 5, when the ring-type apparatus 200 is made to approach the coil 110 of the vehicle 100 by the user coming into contact with the handle 17L or 17R, an induction current is generated in the coil 110, and the induction current is supplied to the authenticator 120 of the vehicle 100 and the authenticator 120 having received the current is activated and transmits an authentication request signal to the remote control apparatus 300.

The authenticator 310 of the remote control apparatus 300 having received the authentication request signal transmits an encryption key, which is pre-stored, to the vehicle 100, and the vehicle 100 having received the encryption key authenticates the remote control apparatus 300 when the received encryption key matches an encryption key that is pre-stored therein.

Here, the encryption key may be a unique ID of the remote control apparatus 300 that is previously registered in the vehicle 100, or may be a password that is mutually shared by the vehicle 100 and the remote control apparatus 300.

Although the coil 110 of the vehicle 100 is illustrated as being provided in the handle 17L or 17R of the door 15L or 15R in the vehicle system according to the embodiments described above, but the position of the coil 110 is not limited thereto.

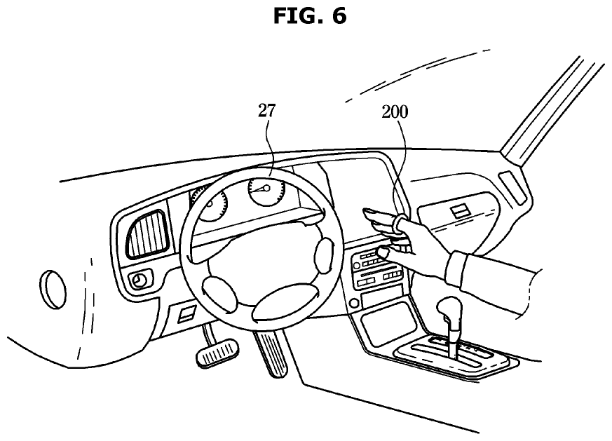

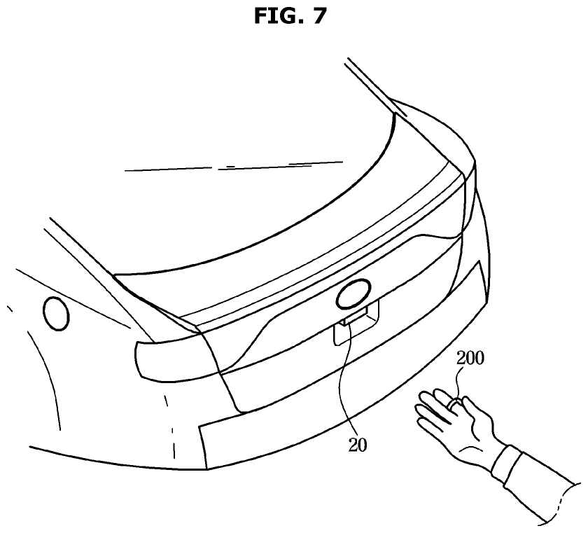

FIGS. 6 and 7 are exemplary views for describing a vehicle system including a ring-type apparatus according to embodiments of the present disclosure.

As shown in FIGS. 6 and 7, the coil 110 may be disposed in various locations so long as it can allow an access of the hand of a user who wears the ring-type apparatus 200, such as the steering wheel 27 or a trunk handle 20 of the vehicle 100.

The authenticator 120 of the vehicle 100 may be also provided in the steering wheel 27 or the trunk handle 20 of the vehicle 100, but the position of the authenticator 120 may be provided in various positions without being limited thereto.

Meanwhile, in another example, the ring-type apparatus 200 and the vehicle 100 may perform the authentication process without the remote control apparatus 300.

FIG. 8 is another control block diagram illustrating a vehicle system according to embodiments of the present disclosure.

As shown in FIG. 8, a vehicle system according to embodiments of the present disclosure includes a vehicle 100 and a ring-type apparatus 200.

The vehicle 100 also includes a coil 110 and an authenticator 120, similar to the vehicle 100 described above, and further includes a wake-up portion 130. Different from the ring-type apparatus 200 according to the above described embodiment, the ring-type apparatus 200 includes a coil 220 and an authenticator 230.

The coil 110 of the vehicle 100 according to embodiments of the present disclosure is magnetized in response to receiving current supplied by the wake-up portion 130. When the coil 110 of the vehicle 100 approaches the coil 220 of the ring-type apparatus 200, an electric current flows through the coil 220 of the ring-type apparatus 200 according to the electromagnetic induction law. For example, when a user wearing the ring-type apparatus 200 allows the ring-type apparatus 200 to approach the coil 110 of the vehicle 100, an induction current may be generated in the coil 220 of the ring-type apparatus 200.

The authenticator 120 of the vehicle 100 according to embodiments of the present disclosure may receive an encryption key from the ring-type apparatus 200. Although not shown, the authenticator 120 of the vehicle 100 may be activated (e.g., turned on, woken up, etc.) by the wake-up portion 130, and when activated, may be turned on to receive an encryption key or may transmit an encryption key request signal to the ring-type apparatus 200 and receive an encryption key from the ring-type apparatus 200 to thereby perform an authentication process.

The authenticator 120 of the vehicle 100 compares the received encryption key with a pre-stored encryption key to determine whether the encryption keys match each other, and when the encryption keys match each other, authenticates the ring-type apparatus 200.

The authenticator 120 of the vehicle 100 may include a wireless communication interface including an antenna and a transceiver for transmitting and receiving a wireless signal to and from the ring-type apparatus 200. In addition, the authenticator 120 may further include a signal conversion module for modulating a digital control signal into an analog type wireless signal through the wireless communication interface or for demodulating an analog type wireless signal received through the wireless communication interface into a digital control signal.

The authenticator 120 of the vehicle 100 includes a processor that performs a series of operations to process data and a memory that stores an algorithm for processing data or data about a program that reproduces an algorithm.

The wake-up portion 130 according to embodiments of the present disclosure may sense a user input, and supply the coil 110 with an electric current to wake up the coil 110 of the vehicle 100 according to the user input. The coil 110 may have magnetic properties by the current supplied from the wake-up portion 130.

In addition, although not shown, the wake-up portion 130 may also wake up the authenticator 120 according to user input. By the current supplied from the wake-up portion 130, the authenticator 120 may be turned on to receive an encryption key from the ring-type apparatus 200, or may transmit an encryption key request signal to the ring-type apparatus 200.

Meanwhile, the wake-up portion 130 may be provided in various forms for sensing a user input. Details thereof will be described later.

The coil 220 of the ring-type apparatus 200 according to embodiments of the present disclosure is formed of a material having conductivity, and a current flows in the coil 220 according to the electromagnetic induction law when the coil 110 of the vehicle 100 having magnetic properties approaches the coil 220 of the ring-type apparatus. For example, when a user wearing the ring-type apparatus 200 allows the coil 220 of the ring-type apparatus 200 to approach the coil 110 of the vehicle 100, an induction current may be generated in the coil 220 of the ring-type apparatus 200, and the coil 220 may supply the generated current to the authenticator 230 of the ring-type apparatus 200.

The authenticator 230 of the ring-type apparatus 200 according to embodiments of the present disclosure may be activated in response to receiving the current supplied from the coil 220, and the activated authenticator 230 may transmit a pre-stored encryption key to the vehicle 100.

Although not shown, the authenticator 230 of the ring-type apparatus 200 may be activated in response to receiving the current supplied from the coil 220, the activated authenticator 230 may be turned on, and in response to receiving an encryption key request signal from the vehicle 100, transmit a pre-stored encryption key to the vehicle 100.

The authenticator 230 of the ring-type apparatus 200 may include a wireless communication interface including an antenna and a transceiver for transmitting and receiving to and from a wireless signal with the vehicle 100. In addition, the authenticator 230 may further include a signal conversion module for modulating a digital control signal into an analog type wireless signal through the wireless communication interface or for demodulating an analog type wireless signal received through the wireless communication interface into a digital control signal.

In addition, the authenticator 230 of the ring-type apparatus 200 may be implemented as a transponder that automatically transmits an encryption key by being activated (e.g., turned on, woken up, etc.).

The authenticator 230 of the ring-type apparatus 200 includes a processor that performs a series of operations to process data and a memory that stores an algorithm for processing data or data about a program that reproduces an algorithm.

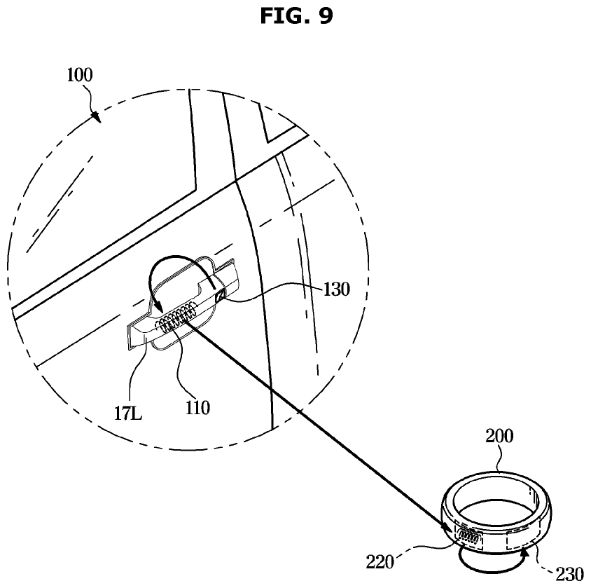

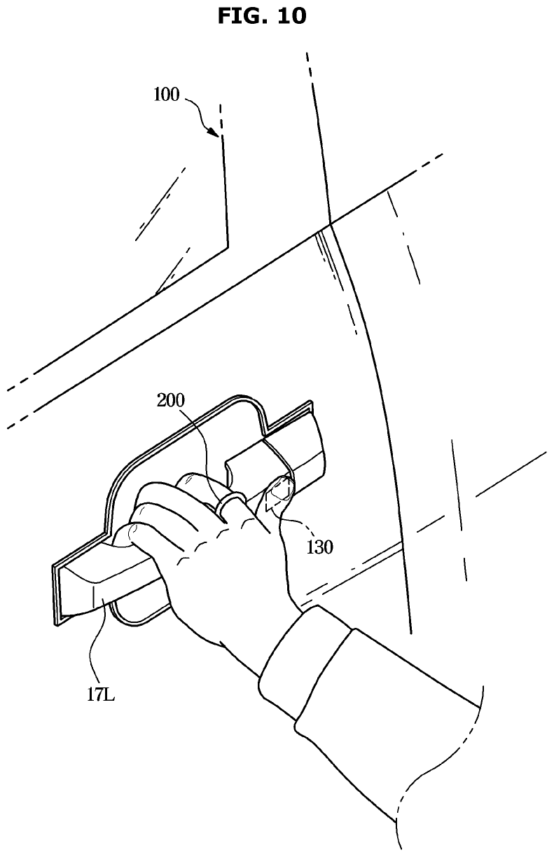

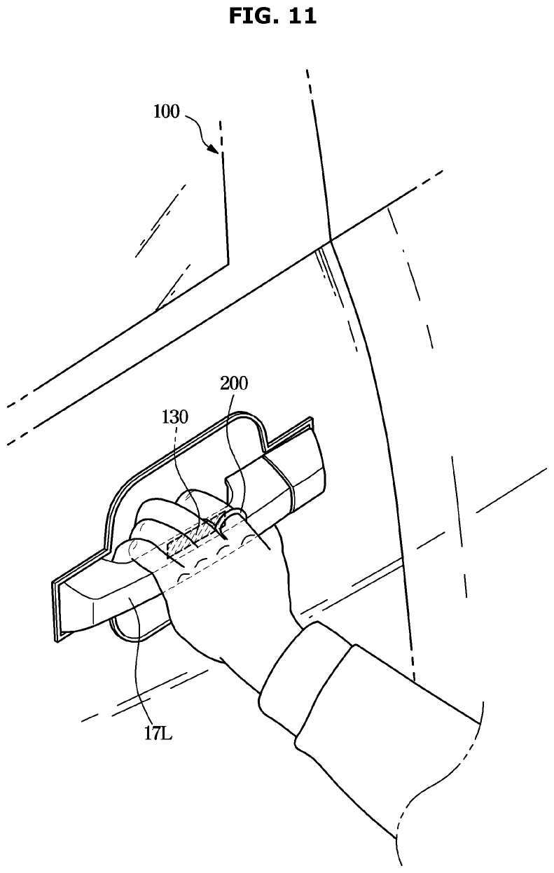

FIG. 9 is another conceptual diagram illustrating a vehicle and a ring-type apparatus according to embodiments of the present disclosure, and FIGS. 10 and 11 are exemplary views illustrating another example in which a ring-type apparatus according to embodiments of the present disclosure is used.

Referring first to FIG. 9, at least one of the coil 110, the authenticator 120, and the wake-up portion 130 of the vehicle 100 described above may be provided in the door 15L or 15R of the vehicle 100 described above with reference to FIGS. 1 and 2, specifically, in the handle 17L or 17R or adjacent to the handle 17L or 17R, but the position of the at least one of the coil 110, the authenticator 120, and the wake-up portion 130 of the vehicle 100 is not limited thereto. Also, in addition to using the right hand of the user, the ring-type apparatus 200 may be worn on the left hand of the user, and the handle 17L or 17R may be pulled by the left hand.

The coil 220 of the ring-type apparatus 200 may be provided in a part of the ring-type apparatus 200 as shown in FIG. 9, but the position of the coil 220 is not limited thereto. The coil 220 may be provided on the entire surface of the outside or the inside, of the ring-type apparatus 200 along the ring shape. The surface of the outside of the ring-type apparatus 200 may refer to the surface of at least one of an outer side and an inner side of the ring-type apparatus 200 exposed to the user, and the surface of the inside of the ring-type apparatus 300 may refer to the surface forming the interior of the ring-type apparatus 300 not exposed to the user.

Referring next to FIG. 10, the wake-up portion 130 may include a button-shaped input device that may be pressed from the outer surface of the handle 17L or 17R. When the user presses the input device of the wake-up portion 130, a current may be supplied to the coil 110, or the authenticator 120 may be turned on. For example, the input device of the wake-up portion 130 may be provided at a position in which the user easily presses the input by the user's thumb when desiring to open the door 15L or 14R by pulling the handle 17L or 17R.

In addition, referring to FIG. 11, the input device of the wake-up portion 130 may include an input in the form of a touch pad provided on the surface of an inner side of the handle 17L or 17R to be touched. When the user touches the input device of the wake-up portion 130, a current may be supplied to the coil 110 or the authenticator 120 may be turned. For example, the wake-up portion 130 may be provided at a position of the handle 17L or 17R in which the user easily touches the wake-up portion 130 with at least one of the second to fifth fingers of the user (i.e., an index finger, a middle finger, a ring finger, and a little finger) when desiring to open the door 15L or 15R by pulling the handle 17L or 17R.

Other than the above description, the input device of the wake-up portion 130 may be provided in the handle 17L or 17R or adjacent to the handle 17L or 17R in various forms to receive the user's input. The input may include various buttons, switches, pedal, a keyboard, a mouse, a track-ball, various levers, a handle, a stick, and other hardware devices to receive the user's input.

As shown in FIGS. 10 and 11, when the vehicle 100 is activated (e.g., turned on, woken up, etc.) by the user's input device of the wake-up portion 130 and a current is supplied to the coil 110, the coil 110 of the vehicle 100 is magnetized and forms a magnetic body, and when the ring-type apparatus 200 approaches the vehicle 100, an induction current is generated in the coil 220 of the ring-type apparatus 200, and then the induction current is supplied to the authenticator 230 of the ring-type apparatus 200. When the current is supplied to the authenticator 230, the authenticator 230 may transmit a pre-stored encryption key to the remote control apparatus 300, or may be turned on and transmit a pre-stored encryption key to the vehicle 100 in response to receiving an encryption key request signal from the vehicle 100.

The vehicle 100 that has received the encryption key may authenticate the ring-type apparatus 200 when the received encryption key matches a pre-stored encryption key.

Although the coil 110 and the wakeup portion 130 of the vehicle 100 in the vehicle system according to embodiments of the present disclosure are illustrated being provided in the handle 17L or 17R of the door 15L or 15R, the locations of the coil 110 and the wake-up portion 130 are not limited thereto.

For example, referring again to FIGS. 6 and 7, the coil 110 and the wake-up portion 130 may be provided in various positions of the vehicle 100 as long as it can allow an access of the hand of a user who wears the ring-type apparatus 200, such as the steering wheel 27 or the trunk handle 20 of the vehicle 100.

The authenticator 120 of the vehicle 100 may also be provided in the steering wheel 27 or the trunk handle 20 of the vehicle 100, but the position of the authenticator 120 is not limited thereto and may be provided in various positions in the vehicle 100.

However, at least one of the above-described components may be added or omitted to correspond to the performance thereof. In addition, it should be readily understood by those skilled in the art that the mutual position of the components may be changed to correspond to the performance or structure of the system.

Meanwhile, some of the components illustrated in FIGS. 1 to 11 may be software and/or hardware, such as a Field Programmable Gate Array (FPGA) and an Application Specific Integrated Circuit (ASIC).

Meanwhile, the disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium. The computer-readable recording medium includes all kinds of recording media in which instructions which can be decoded by a computer are stored, for example, a Read Only Memory (ROM), a Random Access Memory (RAM), a magnetic tape, a magnetic disk, a flash memory, an optical data storage device, and the like.

As is apparent from the above, the ring-type apparatus activates the vehicle without using a battery and/or performs authentication with the vehicle, so that the weight of a battery of the ring-type apparatus can be removed and the discharge with use of a battery can be prevented. The battery consumption of the vehicle can be reduced by obviating a need for the vehicle to continuously transmitting a search signal to search for a remote control apparatus.

Although certain embodiments of the present disclosure have been described for illustrative purposes, those skilled in the art will appreciate that various modifications, additions and substitutions are possible, without departing from the scope and spirit of the disclosure. Therefore, embodiments of the present disclosure disclosed herein have not been described for limiting purposes.

What is claimed is:

1. A vehicle comprising:
a conductive coil; and
an authenticator configured to be activated in response to receiving a current and to request an encryption key from a remote control apparatus, wherein
an induction current is induced in the coil when a magnetic body approaches the coil, and
the authenticator is further configured to be activated in response to receiving the induction current from the coil.

2. The vehicle of claim 1, further comprising a handle configured to open a door of the vehicle,
wherein the coil is disposed in the handle or adjacent to the handle.

3. The vehicle of claim 1, wherein the authenticator is further configured to receive an encryption key from the remote control apparatus, to compare the received encryption key with a pre-stored encryption key, and to authenticate the remote control apparatus based on the comparison of the received encryption key with the pre-stored encryption key.

4. A vehicle system comprising:
a ring-type apparatus including a magnetic body;
a vehicle including a conductive coil and an authenticator configured to be activated in response to receiving a current and to request an encryption key from a remote control apparatus; and
the remote control apparatus which is configured to transmit a pre-stored encryption key to the authenticator in response to receiving an encryption key request signal, wherein
an induction current is induced in the coil when the magnetic body of the ring-type apparatus approaches the coil, and
the authenticator is further configured to be activated in response to receiving the induction current from the coil.

5. The vehicle system of claim 4, wherein the magnetic body of the ring-type apparatus includes at least one of a magnet iron, an electromagnet, and a permanent magnet.

6. The vehicle system of claim 4, wherein the authenticator is further configured to receive an encryption key from the remote control apparatus, to compare the received encryption key with a pre-stored encryption key, and to authenticate the remote control apparatus based on the comparison of the received encryption key with the pre-stored encryption key.

7. The vehicle system of claim 4, wherein the ring-type apparatus includes a ring.

8. A vehicle comprising:
a conductive coil;
a wake-up portion configured to sense an input from a user and to supply the coil with a current in response to sensing the input from the user; and
an authenticator configured to receive an encryption key,
wherein the coil is magnetized in response to receiving a current.

9. The vehicle of claim 8, wherein the wake-up portion is further configured to supply the authenticator with the current in response to sensing the input from the user.

10. The vehicle of claim 9, wherein the authenticator is further configured to be turned on in response to receiving the current from the wake-up portion.

11. The vehicle of claim 9, wherein the authenticator is further configured to transmit an encryption key request signal in response to receiving the current from the wake-up portion.

12. The vehicle of claim 8, further comprising a handle configured to open a door of the vehicle,
wherein the coil is disposed in the handle or adjacent to the handle.

13. The vehicle of claim 8, wherein the authenticator is further configured to compare the received encryption key with a pre-stored encryption key and to authenticate the remote control apparatus based on the comparison of the received encryption key with the pre-stored encryption key.

14. The vehicle of claim 8, wherein the wake-up portion includes an input device in the form of a button to be pressed,
wherein the input device is configured to supply the coil with a current in response to being pressed.

15. The vehicle of claim 14, further comprising a handle configured to open a door of the vehicle,
wherein the input device is disposed in the handle or adjacent to the handle.

16. The vehicle of claim 14, wherein the wake-up portion includes an input device in the form of a touch pad,
wherein the input device is configured to supply the coil with a current in response to being touched.

17. The vehicle of claim 16, further comprising a handle configured to open a door of the vehicle,
wherein the input device is disposed in the handle or adjacent to the handle.

18. A ring-type apparatus comprising:
a coil configured to generate a current when a magnetic body approaches the coil; and
an authenticator configured to transmit a pre-stored encryption key in response to receiving the current from the coil.

19. The ring-type apparatus of claim 18, wherein the ring-type apparatus includes a ring.

20. The ring-type apparatus of 18, wherein the authenticator is configured to be turned on in response to receiving the current from the coil and to transmit a pre-stored encryption key in response to receiving an encryption key request signal.
